(19) United States
(12) Patent Application Publication
(10) Pub. No.: US 2018/0022970 A1
(43) Pub. Date: Jan. 25, 2018

(54) NOVEL THERMOPROCESSABLE FLUOROPOLYMER

(71) Applicant: SOLVAY SPECIALTY POLYMERS ITALY S.P.A., Bollate (IT)

(72) Inventors: Serena CARELLA, Parabiago (IT); Giulio BRINATI, Milano (IT)

(21) Appl. No.: 15/550,403

(22) PCT Filed: Feb. 5, 2016
(86) PCT No.: PCT/EP2016/052489

§ 371 Date: Aug. 11, 2017

(30) Foreign Application Priority Data
Feb. 11, 2015 (EP) 15154654.6

(51) Int. Cl. C09J 127/12; B32B 15/085; B32B 15/20; B32B 27/26; B32B 27/08; B32B 27/34; B32B 27/32; C08F 214/24; B32B 15/18

(52) U.S. Cl. CPC C09J 127/12; C08F 214/245; B32B 15/085; B32B 15/20; B32B 15/18; B32B 27/08; B32B 27/34; B32B 27/322; B32B 27/26; B32B 2307/7246; B32B 2307/714

(57) ABSTRACT

The present invention relates to a novel thermoprocessable fluoropolymer containing ethylene and chlorotrifluoroethylene and/or tetrafluoroethylene, and to a multi-layered article comprising it.

### CROSS REFERENCE TO RELATED APPLICATIONS

This application claims priority from European application No. 15154654.6 filed on 11 Feb. 2015, the whole content of this application being incorporated herein by reference for all purposes.

### TECHNICAL FIELD

The present invention relates to a novel thermoprocessable fluoropolymer containing ethylene and chlorotrifluoroethylene and/or tetrafluoroethylene, and to a multi-layered article comprising it.

### BACKGROUND ART

Fluoropolymers are widely used to protect surfaces from corrosion due to weathering or to chemical agents.

Metal industrial equipments can be protected by the corrosion using coatings based on fluoropolymers, which guarantee chemical inertness toward aggressive environments. Such coatings may need to be applied directly on various metal surfaces, such as for example stainless, galvanized and carbon steel, aluminium, copper, bronze, brass and special alloys.

Also, polyamides, which show poor chemical resistance and permeability to gasolines containing polar substances, have been coupled with fluoropolymers to form multi-layered articles, for example in the preparation of fuel lines in the car industry.

Among the fluoropolymers, copolymers of ethylene (E) with chlorotrifluoroethylene (CTFE) and/or tetrafluoroethylene (TFE), optionally comprising other monomers, are known in the art and suggested as being useful for coating polyamides or metal articles.

For example, EP 1241001 A (AUSIMONT S.P.A) discloses multilayer manufactured articles comprising at least on layer based on thermoprocessable copolymers of ethylene (E) with chlorotrifluoroethylene (CTFE) and/or tetrafluoroethylene (TFE) and with acrylic monomers, and one layer based on polyamides. The examples disclose copolymers of ethylene/chlorotrifluoroethylene (ECTFE) further comprising monomers derived from n-butylacrylate (n-BuA). However, this patent does not provides any example of ECTFE copolymers comprising recurring units derived from acrylic acid and is silent about the coating of metal substrates.

WO 2013/174915 (SOLVAY SPECIALTY POLYMERS ITALY S.P.A.)

discloses a composition for use as a primer coating on a galvanized steel surface, said composition comprising, among the other components, at least one ethylene/chlorotrifluoroethylene (ECTFE) polymer. Said ECTFE polymer can also contain up to 10 mol % of a copolymerizable comonomer, including acrylic acid and methacrylic acid. However, the ECTFE polymers herein disclosed comprise 50/50 mole % ethylene/chlorotrifluoroethylene. Also, the composition is applied as primer coating to a galvanized steel surface and then further coated with a top coat comprising the same ECTFE polymer. This patent application is also silent about the coating of polymeric substrates.

ECTFE copolymers optionally comprising acrylic monomers have been also disclosed in US 2001/0027236 (AUSIMONT S.P.A), US 2002/0156138 (AUSIMONT S.P.A.) and US 2009/0326154 (SOLVAY SOLEXIS S.P.A.). None of the said patent applications discloses or exemplifies ECTFE copolymers comprising specific amounts of acrylic acid monomers.

WO 2011/102549 A (FUJIFILM CORPORATION) discloses polymer sheets that have suitable properties to be used as back sheet for solar batteries. A polymer sheet includes a support and a polymer layer which is directly laminated on the support. The polymer is a polymer containing a repeating unit represented by the following general formula (1):

—(CFX₁—CX₂X₃)— general formula (1)

wherein X₁, X₂ and X₃ each represent any one of a hydrogen atom, a fluorine atom and a perfluoroalkyl group having 1 to 3 carbon atoms. further, the polymer may be a polymer produced by copolymerization of a monomer represented by —(CFX₁—CX₂X₃)— and a copolymerizable monomer other than the former monomer. The following are mentioned—among the others: copolymer of chlorotrifluoroethylene, tetrafluoroethylene and acrylic acid (AA/TFE/CTFE) and copolymer of ethylene, chlorotrifluoroethylene and acrylic acid (AA/CTFE/E).

The amount of the repeating unit represented by General Formula (1) is 70% by mass or more, preferably from 80 to 97% by mass. The polymer preferably contains a repeating unit having—among the others—a carboxyl group in an amount of 0.03% by mass to 20% by mass, more preferably from 0.5 to 10% by mass and even more preferably from 0.5 to 5% by mass. As a consequence, in the terpolymers, the percentage by mass of the repeating units deriving from ethylene are in an amount of from 9.99 to 29.996% by mass, more preferably of from 2.5 to 10% by mass. It is preferred an aqueous polymer dispersion liquid (polymer latex) having a core and a shell of the polymer having the repeating unit represented by —(CFX₁—CX₂X₃)—.

More in particular, Example 27 in Table 2A on page 46 discloses a core made from CTFE/E and a shell made from AA/CTFE/E, wherein the content rate of repeating unit represented by General Formula (1) is 99%. Copolymers of ethylene, chrolotrifluoroethylene and acrylic acid are disclosed in the application, wherein the amount of the acrylic acid is from 0.03 to 20% by mass. Said polymers are prepared by aqueous dispersion, thus obtaining a polymer latex having a core and a shell. The compositions comprising said polymers are then obtained by mixing said latex with water in the presence of surfactants.

Accordingly, this document does not disclose a terpolymer made from CTFE or TFE, AA and E comprising the amounts of CTFE/TFE and E according to the present invention. In addition, this document is completely silent about the problem of adhesion between the polymer and the metallic layers.

WO 2010/096027 (WU HUEY-SHEN) discloses fluorochloro ionomers suitable to be used in polymer electrolyte fuel cells. Example 6 discloses an intermediate which is a terpolymer of E/CTFE/AA, which is prepared as disclosed in Example 4, further referring to U.S. Pat. No. 6,228,963. Thus, the molar ratio between CTFE and AA in the terpolymer is considered of 5 to 1. The copolymerization reaction of the polymers described herein can occur in an aqueous system or in a solvent system. However, emulsion polymerization (including mini- and micro-emulsion) are preferred. Accordingly, this document does not disclose a terpolymer made from CTFE or TFE, AA and E comprising the molar ratio between CTFE and AA according to the present invention. In addition, this document is completely silent about the problem of adhesion between the polymer and the metallic layers.

### SUMMARY OF INVENTION

The Applicant perceived that there is still the need for compositions comprising polymers capable of providing upstanding adhesion to several substrates, in particular upon long term exposure to harsh environmental conditions and without the need of a primer.

The Applicant surprisingly found that the above problem can be solved by using a novel copolymer comprising a specific amount of recurring units derived from acrylic acid.

Thus, in a first aspect, the present invention relates to a polymer [polymer (P)] essentially consisting of:
(a) from 51% to 65% by moles of recurring units derived from chlorotrifluoroethylene (CTFE) and/or tetrafluoroethylene (TFE);
(b) from 0.5% to 10% by moles of recurring units derived from acrylic acid (AA); and
(c) from 31% to 45% by moles of recurring units derived from ethylene (E) in an amount such that the sum of the percentages of the recurring units (a), (b) and (c) is equal to 100% by moles,

wherein the mentioned percentages by moles are based on the total number of moles of recurring units of said polymer (P).

The Applicant surprisingly found that the polymer according to the present invention can be applied to the surface of both polymeric and metal substrates, so as to obtain a coating layer having outstanding adhesion to said substrates.

Also, the Applicant has surprisingly found that the polymer according to the present invention allows to obtain an outstanding adhesion between said coating layer and several substrates, without the need of a primer coating interposed between said coating layer and said substrate.

Last, the Applicant has found that the polymer according to the present invention, which comprises more than 50 mol % of CTFE, can be advantageously processed at lower temperature than polymers comprising 50 mol % of CTFE, so that no degradation occurs during processing.

Then, in a second aspect, the present invention relates to an article comprising:
a substrate having at least one surface [surface (S)] and
at least one layer [layer (L1)] directly adhered to said surface (S), said layer (L1) comprising polymer (P) as defined above.

When the substrate is a polymeric substrate, said layer (L1) advantageously provides improved mechanical properties, reduced water vapour permeability and improved lifetime. When the substrate is a metal substrate, said layer (L1) advantageously provides outstanding protection against corrosion.

### DESCRIPTION OF EMBODIMENTS

For the purpose of the present description and of the following claims, the use of parentheses, for example in expressions like “polymer (P)”, “surface (S)”, “layer (L1)”, etc. has the mere purpose of better distinguishing the symbol or number from the rest of the text and, hence, said parenthesis can also be omitted.

For the purpose of the present description and of the following claims, the expressions “molar percentage”, “mole percent”, “% by mol”, “mol %” indicate the amount (expressed in moles) of a mixture constituent divided by the total amount of all constituents in the mixture (expressed in moles), multiplied by 100.

The expression “consisting essentially of” is intended to indicate that minor amounts of end chains, defects, irregularities and monomer rearrangements are tolerated in the polymer (P).

Polymer (P) typically has a heat of fusion of at least 5 J/g, preferably of at least 10 J/g, more preferably at least 30 J/g, as measured by Differential Scanning calorimetry (DSC), at a heating rate of 10° C./min, according to ASTM D-3418. In a preferred embodiment, said polymer (P) has a heat of fusion of about 18.6 J/g.

Polymer (P) typically has a melt flow index comprised between 0.01 and 75 g/10 min, preferably between 0.1 and 50 g/10 min, more preferably between 0.5 and 30 g/10 min, as measured according to ASTM D-1238 standard procedure at 225° C. and 2.16 Kg. In a preferred embodiment, said polymer (P) has a MFI of about 3 g/10min (225° C./2.16 kg).

Polymer (P) suitable in the process of the invention typically has a melting temperature (Tₘ) of at most 250° C., preferably of at most 220° C. Polymer (P) typically has a melting temperature of at least 120° C., preferably of at least 150° C. More preferably, said polymer (P) has a melting temperature (Tₘ) between 160 and 200° C., more preferably between 170 and 195° C. The melting temperature is determined by Differential Scanning calorimetry (DSC), at a heating rate of 10° C./min, according to ASTM D-3418.

Preferably, the recurring units derived from chlorotrifluoroethylene (CTFE) and/or tetrafluoroethylene (TFE) are in an amount of from 53% to 62% and even more preferably from 54% to 60%, by moles based on the total number of moles of recurring units of said polymer (P).

Preferably, the recurring units derived from acrylic acid (AA) are in an amount of from 0.5% to 9% and even more preferably from 1% to 9%, by moles based on the total number of moles of recurring units of said polymer (P).

The recurring units derived from ethylene (E) can be for example in an amount of from 25% to 48.5%, more preferably from 29% to 46.5% by moles based on the total number of moles of recurring units of said polymer (P). Good results have been obtained with amount from 31% to 45%, by moles based on the total number of moles of recurring units of said polymer (P).

In a preferred embodiments, polymer (P) consists of:
(a) from 58% to 60% by moles, of recurring units derived from chlorotrifluoroethylene (CTFE);
(b) from 1% to 9% by moles of recurring units derived from acrylic acid (AA); and
(c) from 31% to 41% by moles of recurring units derived from ethylene (E), wherein the mentioned percentages by moles are based on the total number of moles of recurring units of said polymer (P).

In a more preferred embodiments, polymer (P) consists of:
(a) from 58% to 60% by moles, of recurring units derived from chlorotrifluoroethylene (CTFE);
(b) from 1.2% to 8.5% by moles of recurring units derived from acrylic acid (AA); and
(c) from 31.5% to 40.8% by moles of recurring units derived from ethylene (E),

wherein the mentioned percentages by moles are based on the total number of moles of recurring units of said polymer (P).

Polymers (P) comprising recurring units derived from ethylene (E) and recurring units derived from chlorotrifluoroethylene (CTFE) will be identified herein below as ECTFE copolymers; polymers (P) comprising recurring units derived from ethylene (E) and recurring units derived from tetrafluoro-ethylene (TFE) will be identified herein below as ETFE polymers.

Within the present invention, ECTFE polymers are preferred.

Polymer (P) according to the present invention can be advantageously prepared by reacting (or in other words, by polymerizing) ethylene (E) and chlorotrifluoro ethylene (CTFE) and/or tetrafluoroethylene (TFE) in the presence of acrylic acid (AA).

The reaction (polymerization) is preferably carried out in suspension, in an organic or aqueous medium.

Preferably, a dispersing agent, such as for example methanol, can be further added to the suspension.

Preferably, the reaction (polymerization) is carried out at a temperature between −40° C. and +100° C., more preferably between −20° C. and +50° C., and even more preferably from −15° C. to +30° C. and at a pressure in the range 0.5-100 bar, more preferably 5-40 bar.

Preferably, the reaction (polymerization) is carried out in the presence of at least one radical initiator.

Suitable radical initiator are selected in the group comprising: bis-acylperoxides, such as bis-trichloroacetyl-peroxide (TCAP) and bis-dichlorofluoracetyl-peroxide; dialkylperoxides, such as diterbutylperoxide; inorganic peroxides soluble in water, such as ammonium or alkaline metal persulphates or perphosphates; dialkylperoxydicarbonates.

Preferably, acrylic acid (AA) is fed in the form of a solution.

Preferably, ethylene (E) is continuously fed during the polymerization.

Examples of articles of the present invention include ducts, industrial tubing, pipes, pumps and tanks.

Polymer (P) is advantageously obtained in the form of dry powder. More preferably, said dry powder has a particle size of from 50 to 250 μm.

Preferably, said substrate is a polymeric substrate or a metal substrate.

Typical polymeric substrates include, for example, polyamide substrate, polyarylamide substrate, such as for example Ixef® PArA, and polyimide substrate. For example, suitable polyamide substrates comprise polyamide 6 (PA 6), polyamide 66 (PA 66), polyamide 11 (PA 11), polyamide 12 (PA 12), polyamide 612 (PA 612). The polyamides can optionally contain one or more diamines, such as protected amines, for example hexamethylen-diaminecarbamate and N,N′-dicinnamylidene-1,6-hexandiamine; C₄-C₂₀ aliphatic diamines, for example dodecyldiamine and decyldiamine; aromatic diamines, for example para-xylilendiamine.

Typical metal substrates include, for example, stainless steel, galvanized stainless steel, carbon steel, copper, aluminium, iron, zinc, cadmium, magnesium, brass, bronze, Monel®, Inconel®.

The thickness of said layer (L1) is not particularly limited. Preferably, the thickness of said layer (L1) is of from 10 to 1500 μm, more preferably from 250 to 1200 μm.

Preferably, said layer (L1) is a continuous layer, completely covering said surface (S).

The article according to the present invention can be advantageously obtained by a process comprising the steps of:
(I) providing a substrate having at least one surface (S);
(II) manufacturing at least one layer (L1) directly adhered to said surface (S), said layer (L1) comprising polymer (P) as defined above.

When a metal substrate is used, step (I-a) of pre-treatment of said surface (S) is preferably performed after step (I) and before step (II), so as to provide a rough surface (S) and to achieve a stronger adhesion between said substrate and layer (L1). Any suitable surface treatment may be employed for this purpose, such as sand or grit blasting, etching, etc.

Also, step (I-b) of cleaning said surface (S) is preferably performed after step (I) or step (I-a) and before step (II), with the aim to remove surface contaminants and zinc corrosion products on galvanized substrates. For example, said step may be performed by ammonia cleaning, alkaline solution cleaning and solvent cleaning.

Step (I-c) of profiling may also be performed after step (I), step (I-a) or step (I-b) and before step (II), with the aim to allow good mechanical bonding of the coating on the surface. For example, sweep-blasting, phosphating and using vinyl butyral acid etch wash primers or acrylic passivations may be used in step (I-c).

In a preferred embodiment, said step (II) is performed by powder coating techniques such as electrostatic deposition, fluidized bed, electrostatic spray, and the like.

Typically, electrostatic spray is performed by means of an electrostatic spray gun, which uses the principle of electrophoresis that electrically polarized particles are attracted to a grounded or oppositely charged surface.

When electrostatic spray is used, output settings can be properly selected by the skilled person. Good results have been obtained by working between 10 and 60 kV and between 5 μA and 40 μA , using OptiFlex® L spray gun from ITW Gema AG.

Typically, the thickness of the layer obtained by electrostatic spray is from 10 to 1500 μm, more preferably from 250 to 1200 μm.

When electrostatic spray is used, a composition [composition (C1)] comprising at least one polymer (P) as defined above and optionally further ingredients is preferably used. Even more preferably, when electrostatic spray is used, polymer (P) in the form of powder as obtained from the synthesis is subjected first to a grinding step in order to reduce the particle size of the powder and then to a sieving step.

Preferably, said grinding step is performed using standard millings, such as for example ball mill, rod mill and the like.

Preferably said sieving step is performed with sieves having openings of less than 200 μm (US standard mesh of 80 or higher).

Suitable further ingredients can be selected for example from organic and/or inorganic filers, such as carbon black, mica and polyphenylene sulfone-based additives (PPSO2), which is commercially available under the trademark Ceramer®.

Preferably, said composition (C1) comprises from 60 to 100 wt % of said polymer (P).

Typically, said composition (C1) is prepared by providing said polymer (P) as disclosed above, and optionally mixing said polymer (P) with the other ingredients defined above in suitable amounts. The mixing step is preferably performed in a suitable powder mixer, such as for example a vertical mixer or a horizontal mixer.

In an alternatively embodiment, said step (II) is performed by compression molding.

When compression molding is used, polymer (P) is first pre-heated or molded, to obtain a plate made from polymer (P). Then, said plate is placed onto the surface of the metal part of the article in a press, heated at a suitable temperature and then pressed.

The temperature and pressure can be selected by the skilled person, depending on polymer (P) used. Good results have been obtained by working at a temperature between 180° C. and 300° C. and at a hydrostatic pressure between 50 and 100 bar.

Typically, the thickness of layer obtained by compression molding is up to 1500 μm, for example from 100 to 1500 μm.

When a polymeric substrate is used, the article according to the present invention can be obtained by electrostatic spray as disclosed above, by compression molding as disclosed above or co-extruding a composition [composition (C2)] comprising at least said polymer (P) with said polymeric substrate. The choice of one or other of these techniques is made on the basis of the use for which the multilayer article according to the present invention is intended, as well as of the desired thicknesses of layer (L1).

For example, multilayer articles intended for being used as pipes, tubes, films, sheets and plaques are preferably manufactured by co-extrusion.

Typically, co-extrusion techniques include co-extrusion-laminating, co-extrusion-blow moulding and co-extrusion-moulding.

A multi-layered article according to the present invention is preferably manufactured by co-extrusion of layer (L1) with the polymeric substrate.

Should the disclosure of any patents, patent applications and publications which are incorporated herein by reference conflict with the description of the present application to the extent that it may render a term unclear, the present description shall take precedence.

The invention will be now described in more detail with reference to the following examples whose purpose is merely illustrative and not limitative of the scope of the invention.

### EXAMPLES

Raw Materials

Chloroform was purchased from Sigma-Aldrich Corp.

Chlorotrifluoroethylene (CTFE) was purchased from Honeywell International Inc.

Ethylene (E) was purchase from SIAD S.p.A.

Acrylic Acid (AA) was purchased from Sigma-Aldrich

Hydroxy propyl acrylate (HPA) was purchased from Sigma-Aldrich Corp.

Hydroxy ethyl acrylate (HEA) was purchased from Sigma-Aldrich Corp.

Polyamide PA612 was purchased from Schulman.

Polyarylamide IXEF® PArA was obtained from SOLVAY SPECIALTY POLYMERS U.S.A.

E/CTFE/AA terpolymer having molar ratio 45.2/50/4.8 was obtained from SOLVAY SPECIALTY POLYMERS ITALY S.p.A.

### EXAMPLE 1

### Synthesis of Polymer (P)

Polymer (P-1) ethylene/chlorotrifluoroethylene/acrylic acid (E/CTFE/AA) 36.2/59/4.8 terpolymer having a melting point (Tₘ) 185.7° C., heat of fusion (ΔH2f) 18 J/g and MFI 3 g/10 min (measured at 225° C./2.16 Kg) was prepared as follows.

In an enamelled autoclave equipped with baffles and stirring at 600 rpm, 3 L of demineralized water, 102 g of chloroform, 33 ml of a solution of acrylic acid (AA) (20% volume) and water (80% volume), and 7 Kg of chlorotrifluoroethylene were introduced.

Then, the temperature was brought to 15° C. and ethylene was fed up to a pressure of 8.2 absolute bars.

During the polymerization, the radical initiator trichloroacetylperoxide

(TCAP) in isooctane having a titre of 0.12 gTCAP/ml and maintained at −17° C. was continuously fed to the autoclave, in the form of solution.

Also, during the polymerization, 33 ml of the same solution of acrylic acid and water were fed at consumption of 20, 40, 60, 80, 100, 120, 140, 160, and 180 g of ethylene.

The polymerization lasted about 540 minutes. During the whole time, the pressure was maintained constant by continuously feeding ethylene to the reactor, up to a consumption of 200 g of ethylene.

At the end of the polymerization, the autoclave was discharged and the product thus obtained was dried at 120° C. for about 16 hours.

1414 g of polymer (P-1) were obtained in the form of powder.

The following E/CTFE/AA terpolymers in the form of dry powder having a molar content of 39.6/59/1.4 (polymer P-2) and 32.7/59/8.3 (polymer P-3) were further prepared following the procedure detailed above, adapting the amount of acrylic acid fed:
polymer (P-2): E/CTFE/AA terpolymers in the form of dry powder having a molar content of 39.6/59/1.4 and Tₘ of 180.8° C.;
polymer (P-3): E/CTFE/AA terpolymers in the form of dry powder having a molar content of 32.7/59/8.3 and Tₘ of 181.8° C.

Polymers P-1, P-2 and P-3 were subjected to grinding in a ball mill for about 10 minutes and then sieved with a 80 US Standard Mesh sieve.

### EXAMPLE 2

### Synthesis of Comparison Polymers Comprising hydroxyl-propyl-acrylate (HPA)

In an enamelled autoclave equipped with baffles and stirring at 600 rpm, 3

L of demineralized water, 60 g of chloroform, 20 ml of a solution of hydroxy-propyl acrylate (HPA) (50% volume) and water (50% volume), and 7 Kg of chlorotrifluoroethylene were introduced.

The polymerization was performed following the procedure disclosed in Example 1 above, feeding 20 ml of the same solution of acrylic acid and water at consumption of 20, 40, 60, 80, 100, 120, 140, 160,180, 200, 220, 240, 260, and 280 g of ethylene.

The polymerization lasted about 490 minutes. At the end of the polymerization, the autoclave was discharged and the product thus obtained was dried at 120° C. for about 16 hours.

1780 g of a polymer having a molar composition E/CTFE/HPA of 36/59/5 (hereinafter referred to as “HPA-1”), in the form of powder, were obtained. Further analysis showed that the melting point was 180° C. and the MFI (measured at 220° C./2.16 Kg) was 0.7 g/10 min.

E/CTFE/HPA terpolymers in the form of powder having a molar content of 39.9/59/1.15 (hereinafter referred to as “HPA-2”) was prepared following the same procedure, adapting the amount of HPA fed.

### EXAMPLE 3

### Synthesis of Comparison Polymers Comprising hydroxyl-ethylene-acrylate (HEA)

In an enamelled autoclave equipped with baffles and stirring at 600 rpm, 3 L of demineralized water, 105 g of chloroform, 12 ml of a solution of hydroxy ethyl acrylate (HEA) (25% volume) and water (75% volume), and 7 Kg of chlorotrifluoroethylene were introduced.

The polymerization was performed following the procedure disclosed in Example 1 above, feeding 12 ml of the same solution of acrylic acid and water at consumption of 20, 40, 60, 80, 100, 120, 140, 160, and 180 g of ethylene.

The polymerization lasted about 370 minutes. At the end of the polymerization, the autoclave was discharged and the product thus obtained was dried at 120° C. for about 16 hours.

1250 g of a polymer having a molar composition E/CTFE/HEA of 39.7/59/1.3 (hereinafter referred to as “HEA-1”), in the form of powder, were obtained. Further analysis showed that the melting point was 176.2° C. and the MFI (measured at 220° C./2.16 Kg) was 8.4 g/10 min.

Also these comparative polymers were subjected to grinding in a ball mill for about 10 minutes and then sieved with a 80 US Standard Mesh sieve.

### EXAMPLE 4

### Manufacturing of Multi-Layered Articles

Multi-layered articles according to the present invention comprising a polymeric or metal substrate and a layer comprising polymers (P-1), (P-2), (P-3) adhered to said substrate were prepared as disclosed below.

First, plates of polymers (P-1), (P-2) and (P-3) having a thickness of 300 μm were prepared as follows.

40-100 g of powder of each polymers (P-1), (P-2) and (P-3) were put within a frame (130×130×0.6 mm). Two foils of polytetrafluoroethylene (PTFE) were then put upon and below to cover the powder in the frame. The frame was then put between two steel plates and then put between the press plates. The press plates were then heated at 220-240° C. for 5 minutes. Then, the procedure was as follows: applying pressure (16 ton/4.5 inch), degassing for 2 minute, and applying pressure a second time (16 ton/4.5 inch). Last, a water cooling step was performed to room temperature.

Plates of comparison polymers (HPA-1), (HPA-2) and (HEA-1) were also prepared according to the same procedure.

4a—Multi-Layered Article Comprising a Polymeric Substrate (by Compression Molding)

A molded plaque of PA612 having a thickness of 300 micron and the plaque of polymer (P-1) obtained as disclosed above were overlapped in a frame (sized 130×130×0.6 mm) preheated for 5 minutes at 240° C. The plaques were molded for 4 minute at 240° C., under the pressure of 75 bar. Fast cooling was then performed in cold water plates.

A plaque of IXEF® PArA having a thickness of 300 micron and the plaque of polymer (P-1) obtained as disclosed above were overlapped and molded together following the same procedure.

Plaques of PA612 and IXEF® PArA were molded with comparison polymer (HPA-1) according to the same procedure.

4b—Multi-Layered Article Comprising a Metal Substrate (by Compression Molding)

A plaque of copper having a thickness of 300 micron was first cleaned with acetone and then overlapped to a molded plaque of polymer (P-2) obtained as disclosed above having a thickness of 1.5 mm, in a frame (sized 130×80×1.5 mm) preheated for 5 minutes at 225° C. The molding step was performed for 4 minute at 225° C., under the pressure of 80 bar. Fast cooling was then performed in cold water plates.

A plaque of aluminium having a thickness of 300 micron was similarly treated, then overlapped to a molded plaque of polymer (P-2) obtained as disclosed above having a thickness of 1.5 mm, and treated as disclosed above with respect to the copper plaque.

Plaques of copper and aluminum and comparison polymers (HEA-1) and (HPA-2) were also prepared according to the same procedure.

4c—Multi-Layered Article Comprising Galvanized Metal Substrate (by Electrostatic Powder Coating)

The surfaces of galvanized steel test specimens (15×15 cm) were sandblasted (using 16 mesh sand) and cleaned with ammonia.

Each of polymers (P-1) and (P-3) was applied on the cleaned surface of a test specimen by electrostatic powder coating, using OptiFlex® L spray gun from ITW Gema AG and working between 30 and 50 kV and between 15 μA and 30 μA.

The coated specimens were heated in an oven at 220° C. for 20 minutes, and then allowed to cool to 25° C.

A uniform coating, free of cracks and visible imperfections, was obtained on the surface of each test specimen. No discoloration was observed upon heating/cooling of the coated specimen.

A second layer of coating comprising polymer (P-1) or (P-3), respectively, was applied, following the same procedure disclosed above. Similar results in terms of visual appearance were obtained.

### EXAMPLE 5

### Evaluation of the Adhesion

5a—Adhesion of Multi-Layered Article Comprising a Polymeric Substrate

The adhesion of the multi-layered articles obtained in Example 4a disclosed above was evaluated by a peeling test, performed according to ASTM D1876 at 23° C., 50% R.H (relative humidity).

The results are reported in the following Table 1.

TABLE 1

| | Peeling strength [N/cm] | |
|---|---|---|
| | PA612 | IXEF ® PArA |
| HPA-1(*) | n/a | 1.6 |
| P-1 | 5.2 | 78 |

(*)comparison
n/a: not applicable

The adhesion of HPA-1 on PA612 was not performed because polymer

HPA-1 was already detached from the PA612 substrate before starting the test.

The above results clearly demonstrate that by using polymer (P-1) according to the present invention, better results in term of adhesion to different polymeric substrates are achieved.

5b—Adhesion of Multi-Layered Article Comprising a Metal Substrate

The adhesion of the multi-layered articles obtained in Example 4b disclosed above was evaluated by a peeling test, performed according to ASTM D1876 at 23° C., 50% R.H (relative humidity).

The results are reported in the following Table 2.

TABLE 2

| | Peeling strength [N/cm] | |
|---|---|---|
| | Copper | Aluminium |
| HEA-1(*) | 9 | 6.6 |
| HPA-2(*) | 8.8 | 9.6 |
| P-2 | 23 | 19.3 |

(*)comparison

The above results clearly demonstrate that by using polymer (P-2) according to the present invention, better results in term of adhesion to different metal substrates are achieved.

5c—Adhesion of Multi-Layered Article Comprising Galvanized Metal Substrate

The adhesion of the multi-layered articles obtained in Example 4c disclosed above was evaluated by a peeling test, according to ASTM D1876 at 23° C., 50% R.H (relative humidity). This test was performed few hours after the manufacture of the multi-layered article (t=0).

An accelerated ageing test was also performed with the aim to stress the multi-layered articles by vapour exposure. The adhesion was evaluated by a peeling test, after the multi-layered articles was exposed to vapour at 85° C. for 10 days (t=10).

The results are reported in the following Table 3.

TABLE 3

| | Peeling strength [Kg/cm] | |
|---|---|---|
| | t = 0 | t = 10 |
| P-1 | 20 | 20 |
| P-3 | 20 | 20 |

The above results clearly demonstrate that the polymers according to the present invention allow to achieve outstanding adhesion to galvanized metal substrates, also after exposure to harsh conditions (humidity).

The Applicant tried to perform the same test using polymer HPA-1 as comparison. However, the Applicant found that it was not possible obtain a continuous film after electrostatic deposition and heating of HPA-1.

Dynamic time sweep test (according to ASTM D4440) was performed to demonstrate the tendency of HPA-1 to crosslinking under processing conditions. The test was performed in a rheogoniometer rheometrics RMS 800 in a parallel plate configuration (d=25 mm) at 230° C. Frequency of oscillation was 1 rad/s. Complex viscosity (η−eta) was monitored as function of time for 1 hour and the results are reported in the following Table 4.

TABLE 4

| Time (s) | η (Pa*s) |
|---|---|
| 300 | 1200 |
| 1800 | 3000 |
| 3600 | 5000 |

### EXAMPLE 6

### Evaluations of Degradation

Optical properties of ECTFE copolymer according to the present invention and of an ECTFE copolymer comprising 50 wt. % of CTFE were measured using an instrument BYK spectro-guide D45 10°.

Yellowness index (B*, YI and WI) were evaluated according to ASTM E-313.

The results are reported in the following Table 4.

TABLE 4

| | E/CTFE/AA | |
|---|---|---|
| | 45.2/50/4.8(*) | P-1 |
| b* | 25 | 7 |
| YI | 58 | 13 |
| WI | 21 | 65 |

(*)comparison

The above results clearly show that E/CTFE/AA terpolymer having a content of CTFE of 50 mol % was not stable and more susceptible to degradation.

1. A polymer (P) essentially consisting of:
(a) from 51% to 65% by moles of recurring units derived from chlorotrifluoroethylene (CTFE) and/or tetrafluoroethylene (TFE);
(b) from 0.5% to 10% by moles of recurring units derived from acrylic acid (AA); and
(c) from 31% to 45% by moles of recurring units derived from ethylene (E) in an amount such that the sum of the percentages of the recurring units (a), (b) and (c) is equal to 100% by moles,
wherein the mentioned percentages by moles are based on the total number of moles of recurring units of said polymer (P).

2. Polymer (P) according to claim 1, wherein the recurring units derived from chlorotrifluoroethylene (CTFE) and/or tetrafluoroethylene (TFE) are in an amount of from 53% to 62%, by moles based on the total number of moles of recurring units of said polymer (P).

3. Polymer (P) according to claim 2, wherein the recurring units derived from chlorotrifluoroethylene (CTFE) and/or tetrafluoroethylene (TFE) are in an amount of from 54% to 60%, by moles based on the total number of moles of recurring units of said polymer (P).

4. Polymer (P) according to claim 1, wherein the recurring units derived from acrylic acid (AA) are in an amount of from 0.5% to 9% by moles based on the total number of moles of recurring units of said polymer (P).

5. Polymer (P) according to claim 3, wherein the recurring units derived from acrylic acid (AA) are in an amount of from 1% to 9%, by moles based on the total number of moles of recurring units of said polymer (P).

6. Polymer (P) according to claim 1, said polymer (P) consisting of:
(a) from 58% to 60% by moles of recurring units derived from chlorotrifluoroethylene (CTFE);
(b) from 1% to 9% by moles of recurring units derived from acrylic acid (AA); and
(c) from 31% to 41% by moles of recurring units derived from ethylene (E),
wherein the percentages by moles are based on the total number of moles of recurring units of said polymer (P).

7. Polymer (P) according to claim 1, said polymer (P) consisting of:
(a) from 58% to 60% by moles of recurring units derived from chlorotrifluoroethylene (CTFE);
(b) from 1.2% to 8.5% by moles of recurring units derived from acrylic acid (AA); and
(c) from 31.5% to 40.8% by moles of recurring units derived from ethylene (E), wherein the percentages by moles are based on the total number of moles of recurring units of said polymer (P).

8. A method for manufacturing polymer (P) as defined in claim 1, said method comprising reacting ethylene (E) and chlorotrifluoro ethylene (CTFE) and/or tetrafluoroethylene (TFE) in the presence of acrylic acid (AA).

9. The method according to claim 8, wherein the reaction of ethylene (E) and chlorotrifluoro ethylene (CTFE) and/or tetrafluoroethylene (TFE) in the presence of acrylic acid (AA) is carried out in suspension.

10. The method according to claim 8, wherein the reaction of ethylene (E) and chlorotrifluoro ethylene (CTFE) and/or tetrafluoroethylene (TFE) in the presence of acrylic acid (AA) is carried out at a temperature between −40° C. and +100° C. and at a pressure in the range 0.5-100 bar.

11. An article comprising:
a substrate having at least one surface (S) and
at least one layer (L1) directly adhered to said surface (S), said layer (L1) comprising polymer (P) as defined claim 1.

12. The article according to claim 11, wherein said substrate is a polymeric substrate or a metal substrate.

13. The article according to claim 12, wherein said polymeric substrate is selected from group consisting of a polyamide substrate, a polyarylamide substrate, and a polyimide substrate.

14. The article according to claim 12, wherein said metal substrate is selected from the group consisting of stainless steel, galvanized stainless steel, carbon steel, copper, aluminium, iron, zinc, cadmium, magnesium, brass, bronze, Monel®, and Inconel®.

15. A method for manufacturing an article as defined in claim 11, said method comprising the steps of:
(I) providing a substrate having at least one surface (S);
(II) manufacturing at least one layer (L1) directly adhered to said surface (S), said layer (L1) comprising polymer (P).

16. An article comprising:
a substrate having at least one surface (S) and
at least one layer (L1) directly adhered to said surface (S), said layer (L1) comprising polymer (P) as defined claim 7.

17. The article according to claim 16, wherein said substrate is a polymeric substrate or a metal substrate.

18. The article according to claim 17, wherein said polymeric substrate is selected from the group consisting of a polyamide substrate, a polyarylamide substrate, and a polyimide substrate.

19. The article according to claim 17, wherein said metal substrate is selected from the group consisting of stainless steel, galvanized stainless steel, carbon steel, copper, aluminium, iron, zinc, cadmium, magnesium, brass, bronze, Monel®, and Inconel®.
